(19) United States
(12) Patent Application Publication
(10) Pub. No.: US 2023/0064737 A1
(43) Pub. Date: Mar. 2, 2023

(54) METHOD AND APPARATUS FOR REMOVING SPECIFIC CONTAMINANTS FROM WATER IN A RECIRCULATING OR LINEAR TREATMENT SYSTEM

(71) Applicants: HYDRENESIS DELTA SYSTEMS LLC, POMPANO BEACH, FL (US); Natural Aquatic Systems LLC, Dallas, TX (US)

(72) Inventors: Luke Stephen Timmons, Pompano Beach, FL (US); Matthew Richard Rece, Fort Lauderdale, FL (US); Thomas C. Untermeyer, San Antonio, TX (US); F. William Gillmore, Parker, CO (US)

(73) Assignees: HHYDRENESIS DELTA SYSTEMS LLC, POMPANO BEACH, FL (US); Natural Shrimp Corporation, Dallas, TX (US)

(21) Appl. No.: 17/895,906

(22) Filed: Aug. 25, 2022

Related U.S. Application Data
(60) Provisional application No. 63/237,087, filed on Aug. 25, 2021.

(51) Int. Cl. C02F 1/467; C02F 1/58

(52) U.S. Cl. CPC C02F 1/4674; C02F 1/586; C02F 2101/38

(57) ABSTRACT

A method and apparatus for removing specific contaminants from an aqueous solution in a recirculating tank or linear treatment system is described. An aqueous solution is pumped into a reaction chamber. Measurements from the aqueous solution are collected, including one or more of Free Chlorine, Total Chlorine, Total Ammonia Nitrogen, pH, bacteria in the tank, and Oxidation Reduction Potential. In response to the measurements collected, one or more of pump speed, injection of pH precursors prior to the reaction chamber, reaction chamber electrode voltage, current, infusion rate of the chlorine, and contact time of the aqueous solution with the chlorine, are adjusted.

### CROSS-REFERENCE TO RELATED APPLICATIONS

This application claims the benefit of U.S. provisional application No. 63/237,087, filed on Aug. 25, 2021

### BACKGROUND

The described embodiments relate to a method and a system for removing specific contaminants from water in a recirculating or linear treatment system.

A method and apparatus for removing specific contaminants from any aqueous solution in a recirculating or linear treatment system is disclosed. The circulation system often includes a chamber or fluid tank (typically holding an aqueous solution, such as fresh water or salt water) that stores aquaculture. The contaminants from the tank resulting from waste from the aquaculture (such as ammonia) are combined with various chemicals. The solution is then fed across electrical-powered plates of electrodes to generate a electrolytic reaction with the waste and chemicals in the solution to reduce bacteria and contaminants in the solution. The solution is then fed to filters and scrubbers (to clean the solution and remove byproducts resulting from the reaction) before being injected back into the tank or distributed to the point of use.

Methods for removing specific contaminants from any aqueous solution have been studied in various forms for several decades. However, their implementations and variations presented drawbacks. Electrolytic processes are executed in an atmospheric chamber, requiring liquid level controls, multiple pumps for each process instance, and a high probability of fluid overflow. These requirements potentially damage surrounding equipment or nearby power systems.

Further, undissolved gasses from each process instance create exposure to the atmosphere, potentially resulting in atmospheric contamination as some of the gasses are corrosive or flammable.

The difficulty in balancing multiple pumps and varying flowrates creates problems in applying the correct amount of power to the electrolytic cell, relative to the flowrate and water quality of the target aqueous solution.

When using systems to chlorinate or coagulate through electrolytic means, providing the correct chemical dosage is essential for effectively removing the contaminants. At breakpoint chlorination, all chlorine added to the solution is consumed by chemical reactions with the contaminants, resulting in little free available chlorine in the treated water. However, monitoring and adjusting the systems to achieve the breakpoint become burdensome due to the multiplicity of parameters, the relatively small target window of chemical dosage, and the contact time necessary to neutralize organic loads, combine chlorine and ammonia, effectively kill bacteria, and remove the byproducts at the final stage.

In a commercial or industrial application, missing a chlorine dosage target can damage products, equipment, or biological species. The process demands precision but achieving continuous precise dosage of chemicals would greatly increase the life of supplementary products, such as filtration media, components of the electrolytic cell, and the general infrastructure of the facility.

Conducting “breakpoint chlorination” is a complex process that must currently be controlled by highly experienced operators, thereby limiting the flexibility of a commercial operation.

### BRIEF SUMMARY

In one aspect, a method for removing specific contaminants from an aqueous solution by disinfecting and removing organic compounds, ammonia, and ammonium ions that exist in equilibrium in the aqueous solution, the method includes pumping (with a pump having a variable pump speed) the aqueous solution from a holding vessel, either in a recirculation loop or a linear path, into a sealed and pressurized reaction chamber that includes positive electrodes and negative electrodes. From an electric power source, supplying a voltage and current to the positive electrodes and negative electrodes in the reaction chamber to generate chlorine from chloride ions infused within the aqueous solution that reacts with the ammonia and the ammonium ions in the aqueous solution to form chloramine. Using sensors, automatically collecting measurements from the aqueous solution, including one or more of Free Chlorine, Total Chlorine, Total Ammonia Nitrogen, pH, bacteria present, and Oxidation Reduction Potential, and automatically adjusting, in response to the measurements collected from the sensors, one or more of pump speed, injection of pH precursors prior to the reaction chamber, reaction chamber electrode voltage, and/or the current supplied to the positive electrodes and the negative electrodes, results in infusing chlorine at a specific ideal dosage. Once the process has been applied, the biproducts can be easily removed with a suitable filtration media.

In one aspect, a computing apparatus includes a processor. The computing apparatus also includes a memory storing instructions that, when executed by the processor, configure the apparatus to pump an aqueous solution from a holding vessel into a sealed and pressurized reaction chamber that contains positive electrodes and negative electrodes to generate chlorine from chloride ions infused within the aqueous solution that reacts with the ammonia and the ammonium ions in the aqueous solution, automatically collect with sensors measurements from the aqueous solution. The measurements include one or more of Free Chlorine, Total Chlorine, Total Ammonia Nitrogen, pH, bacteria present, and Oxidation Reduction Potential. The processor configure the apparatus to automatically adjust, in response to the measurements collected from the sensors, one or more of pump speed, injection of pH precursors, reaction chamber electrode voltage supplied to positive and negative electrodes, current applied to the positive and negative electrodes, and thereby controlling the infusion rate of chlorine.

In one aspect, an apparatus for removing specific contaminants from an aqueous solution by disinfecting and removing organic compounds, ammonia, and ammonium ions that exist in equilibrium in the aqueous solution includes a pump to move the aqueous solution from a tank or a holding vessel into a sealed and pressurized reaction chamber, an injection system to dose pH precursors into the aqueous solution such that the chlorine created in the reaction chamber reacts with the ammonia and the ammonium ions to generate chloramine, one or more sensors to automatically collect measurements from the aqueous solution, the measurements including one or more of Free Chlorine, Total Chlorine, Total Ammonia Nitrogen, pH, bacteria in the tank, and Oxidation Reduction Potential, and automatically adjusting, in response to the measurements collected from the sensors, one or more of pump speed, injection of pH precursors, reaction chamber electrode voltage, current, and infusion rate of the chlorine production. In some applications, adding beneficial minerals or additives may need to be added after the process to neutralize the pH or achieve a specific water quality metric, after the chemical reaction. This process is referred to as remineralization.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system diagram illustrating the operation of a recirculating or linear system;

FIG. 2 illustrates a multiplicity of planer mechanical diagrams illustrating a novel electrochemical cell assembly;

FIG. 3 illustrates a simplified electronic system diagram illustrating the operational control of the aquaculture recirculating system shown in FIGS. 1 and 2; and

FIG. 4 illustrates a flow diagram of a process for removing contaminants from an aqueous system, executed by the logic controller shown in FIG. 3.

### DETAILED DESCRIPTION

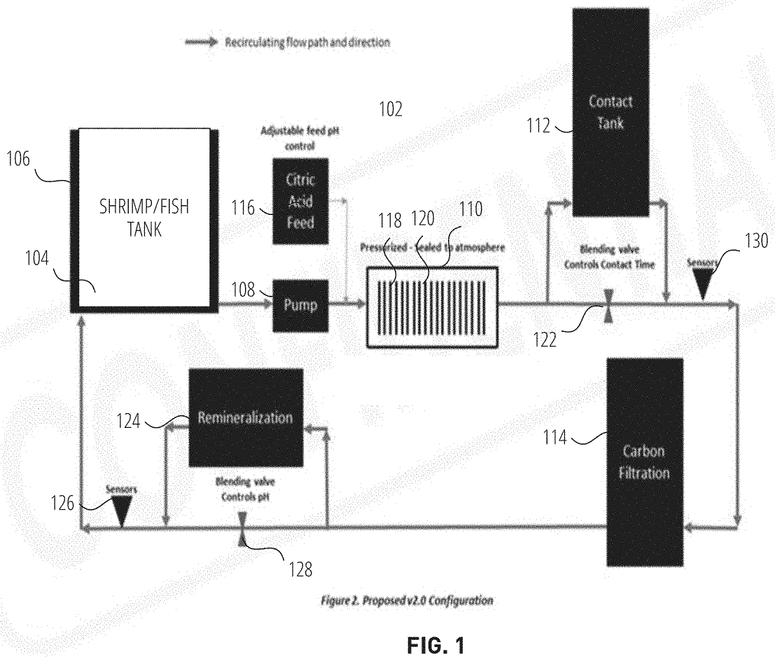

In FIG. 1 there is shown a system 102 for disinfecting and removing contaminants from water (or other fluids, herein referred to as “aqueous solution 104”) in an aqueous system. In one implementation, fluid is remediated by removing organic compounds, ammonia, ammonium ions that exist in equilibrium, bacteria generated from industrial processes, and fish/shrimp (or other aquatic species) waste in an aqueous tank 106, also referred to as a holding vessel. System 102 may be set up in either a recirculation loop or as a linear path and be completely pressurized with the aqueous solution 104 being fed by a pump 108 having a variable pump speed. The aqueous solution 104 is fed in response to the pump 108 from the aqueous tank 106 to the reaction chamber 110 and then fed via the contact tank 112, via the carbon filter 114 and the remineralization blending system 124 back to the tank 106.

The fed aqueous solution 104 is combined with an acid or base (pH precursor) from pH feed 116 (adjustable feed control) to neutralize the aqueous solution 104 and bring the pH of the aqueous solution 104 to neutral (or as close to a pH of 7.0 as possible) prior to and before entering a sealed and pressurized reaction chamber 110.

The aqueous solution 104 in the reaction chamber 110 is treated by applying electrolysis to the chloride solution (which is a brine, saline, or other aqueous based solution) being an effluent biproduct. In the reaction chamber 110, an adjustable power source (not shown) applies voltages and current to positive electrodes 118 and adjacent negative electrodes 120 at various electrode voltage levels to cause an electrolytic process, i.e., electrolysis. Electrolysis is applied to the aqueous solution 104 in reaction chamber 110, which also contains both sufficient chlorides, ammonium ions and a concentration of ammonia, to generate a reaction resulting in chloramine and chlorine. Moreover, the electrolytic process occurs in reaction chamber 110 that converts chloride ions infused within the aqueous solution 104 such that the aqueous solution 104 in the reaction chamber 110 reacts with the ammonia and the ammonium ions to generate chloramine and chlorine.

The output fluid from the electrolysis reaction chamber 110 now infused with chlorine, is then fed into a contact tank 112. Contact tank 112 in combination with a contact tank blending valve 122 (the combination referred to herein as an infuser), provides contact time between the generated free chlorine and bacteria to disinfect and reduce total organic load, kill and/or reduce bacteria and react with the ammonia and the ammonium ions in the aqueous solution. A contact tank blending valve 122 (for consistent flow, a flow rate control valve may be used) may be coupled in parallel with the contact tank 112 to control the contact time of chlorine and the solution and time aqueous solution flows in contact tank 112. The resulting fluid is flowed through a carbon filter 114 to remove the combined and created impurities and possibly fed into a remineralization blending system 124 (to add saline, acids, or bases to adjust the pH balance) with a contact tank blending valve 122, before being delivered to point of use or fed back into source aqueous tank 106.

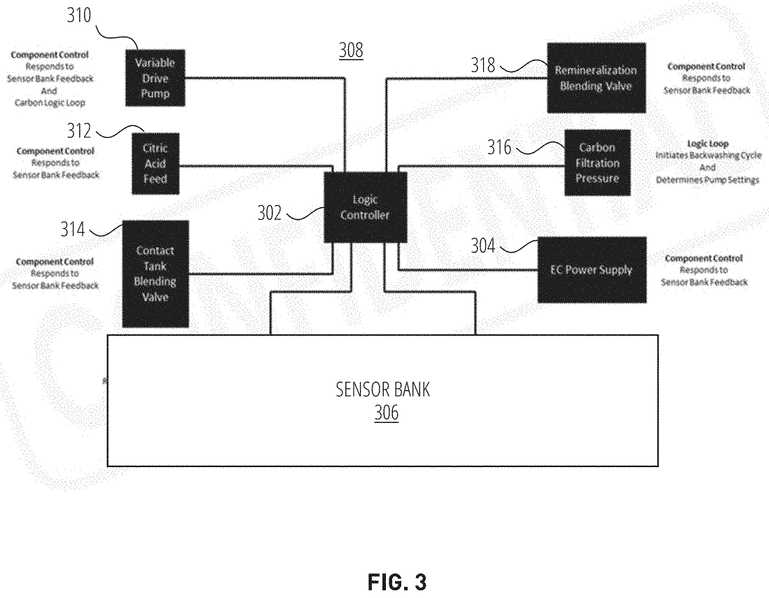

The remineralization blending system 124 responds from feedback received from pH sensor 126 to adjust pH bleeding valve 128 to produce the target pH of the aqueous solution in tank 106. pH bleeding valve 128 controls the flow rate of the aqueous solution through remineralization blending system 124. An oxygen reducing gas may be infused into the aqueous solution 104 after the remineralization blending system 124 to adjust Oxidation Reduction Potential. The oxygen reducing gas infusion rate may be set by logic controller 302 (See FIG. 3) in response to sensed Oxidation Reduction Potential levels in the aqueous solution 104.

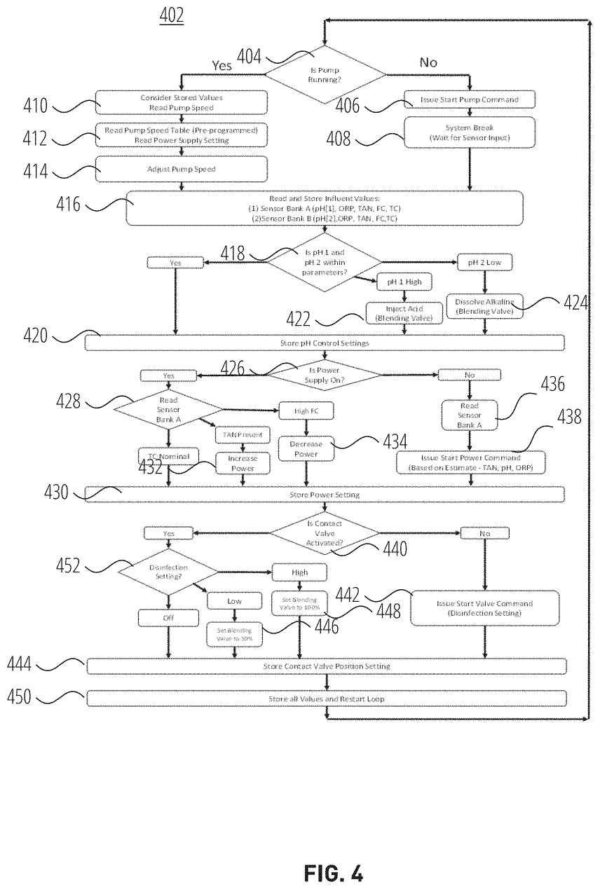

System 102 includes sensors 130, which are described in detail in connection with FIGS. 3 and 4. Sensors 130 and pH sensors 126 refer to one or more sensors that obtain measurements from the aqueous solution 104, the measurements including one or more of Free Chlorine, Total Chlorine, Total Ammonia Nitrogen, pH, bacteria in the tank, and Oxidation Reduction Potential. Sensors 130 may be connected to a fluid sensor (not shown, and may include by way of example a sonic sensor, paddle wheel, or infrared detector)) to detect a flow rate of solution through reaction chamber 110. System 102 also includes a bacteria sensor (not shown) in tank 106. One such bacteria sensor is described in Clausen, C. H.; Dimaki, M.; Bertelsen, C. V.; Skands, G. E.; Rodriguez-Trujillo, R.; Thomsen, J. D.; Svendsen, W. E. Bacteria Detection and Differentiation Using Impedance Flow Cytometry. Sensors 2018, 18, 3496, the contents of which are hereby incorporated by reference.

A logic controller 302 (See FIG. 3) is coupled to pump 108, pH feed 116, power supply 304 (See FIG. 3), contact tank blending valve 122, pH sensor 126, pH bleeding valve 128 and sensor bank 306 (See FIG. 3). Logic controller 302 automatically adjusts, in response to the measurements collected from the pH sensors 126, flow rate sensor (not shown) and sensors 130, one or more of pump speed, injection of pH precursors before the reaction chamber 110 (by controlling pH feed 116), the production rate of chlorine in the sealed and pressurized reaction chamber 110, by adjusting the voltage and current of negative electrodes 120 and positive electrodes 118, and the contact time for chlorine disinfection by setting the opening of contact tank blending valve 122 to increase or decrease the disinfection time in contact tank 112. Specific details of this process are described in FIG. 4.

Pump 108p moves the aqueous solution 104 along a path from the holding vessel or tank 106 via the reaction chamber 110 via contact tank 112, via a carbon filter 114 and via a remineralization blending system 124 back to the holding vessel or tank 106. In one implementation, the aqueous solution 104 remains under pressure along and throughout the path.

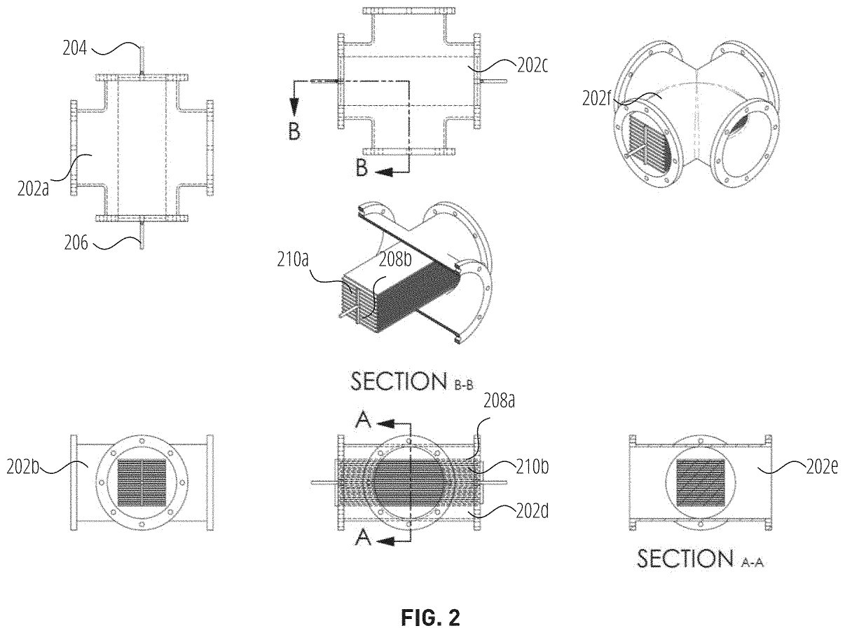

Referring to FIG. 2, there is shown an exemplary reaction chamber 202a, 202b, 202c, 202d, 202e and 202f, which are reaction chamber 110 of FIG. 2. Reaction chambers 202a-202f are preferably pressure sealed using conventional techniques. An anode terminal 204 is inserted into the reaction chamber 202a-202f, and an opposing cathode terminal 206 is also inserted into the chamber 202a-202f. Reaction Chamber 202a-202f is sealed around cathode terminal 206 and anode terminal 204. Anode terminal 204 and cathode terminal 206 are electrically connected to a positive terminal and a negative terminal respectively of a Variable Direct Current (DC) power source (not shown). Anode terminal 204 and cathode terminal 206 are connected to exemplary positive electrodes 208a (also positive electrodes 208b) and negative electrodes 210a (also negative electrodes 210b), respectively, which may be made from various metals or suitable conductive electrode that are compatible with the other chemicals in the system such as titanium, stainless steel, or carbon allotropes, and the anode may be further plated with various mixed metal oxides such as Ruthenium (IV) Oxide (RuO₂) or Iridium Oxide (IrO₂) to extend the life and reduce corrosion. Positive electrodes 208a and negative electrodes 210a may be in parallel or series configuration.

Referring to FIG. 3, there is shown a system diagram for removing contaminants from a solution in a recirculating or linear system 308 shown in FIG. 1. The linear system 308 includes a logic controller 302, which may be a processor or a microprocessor with associated memory (the combination generally referred to as a computing apparatus) and instructions set, coupled with input/output control logic. Logic controller 302 is connected to a variable drive pump 310, citric acid Feed 312, contact tank blending valve 314, sensor bank 306, a DC power supply 304 (which powers reaction chamber 202a), carbon filtration pressure sensor 316 (which controls carbon backwash operation), remineralization blending valve 318, and bacteria sensor (not shown). Logic controller 302 changes the pump speed of the Variable drive pump 310 in response to feedback from sensor bank 306 and carbon filtration pressure sensor 316. The potential of Hydrogen (pH) (pH feed 116) is controlled in response to sensor bank 306 feedback. Contact tank blending valve 122 is also controlled in response to sensor bank 306 feedback. Carbon filtration flow and backwash operation data is sent to logic controller 302 to initiate a backwashing cycle and determine pump 108 flow settings. Contact tank blending valve 122, power supply 304 activation/settings and remineralization blending valve 318 are set in response to feedback from the sensor bank 306.

Sensor bank 306 may include one or more sensors for detecting and monitoring voltage levels of the positive electrodes 118 and negative electrodes 120 in the reaction chamber 110, to monitor and determine a flow rate of the aqueous solution 104 passing through the reaction chamber 110, and a current applied to the positive electrodes 118 and the negative electrodes 120 in reaction chamber 110. Sensor bank 306 may also be coupled with one or more sensors to detect a presence of nitrites in aqueous solution 104.

Logic controller 302 may automatically provide an electrode plate voltage indication alarm signal (via a network connection and not shown) indicating an electrode plate degradation when voltage levels across the positive electrodes 118 and the negative electrodes 120 fall below a predetermined level at a preset current and a preset flow rate. Logic controller 302 may automatically change a flow of aqueous solution 104 being fed to the contact tank 112 by opening or closing the contact tank blending valve 122 to adjust the presence of nitrites in the aqueous solution 104.

The exemplary process in FIG. 4 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer executable instructions include routines, programs, objects, components, data structures, and the like that perform functions or implement abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 4, there is shown a flowchart of Process 402 performed by logic controller 302 when executing the software instructions. The Process 402 includes multiple blocks 404-450.

In Process 402, controller 302 determines if the drive pump 108 is operating in block 404. If it is not, in block 406, logic controller 302 issues a “start pumping” command. In block 408, logic controller 302 issues a system break, waits for a sensor input, and executes block 408. In Process 402, if controller 302 determines that the pump 108 is operating, then in block 410, logic controller 302 evaluates stored values and reads the pump 108 speed. In block 412, controller 302 reads a pump speed table that is preprogrammed and reads the pump power supply settings.

In block 414, logic controller 302 adjusts the pump speed of pump 108 based on preprogrammed table and then executes block 408.

In this description, Free Chlorine is referred to as FC, Total Chlorine is referred to as TC, Total Ammonia Nitrogen is referred to as TAN, and Oxidation Reduction Potential is referred to as ORP.

In block 416, logic controller 302 reads and stores influence values for sensor bank 306, including pH, ORP, TAN, FC, TC. pH sensors 126 and sensors 130 are shown in FIG. 1, but sensors are not limited to where shown and may be positioned at other locations in the system 102. Also in block 416, logic controller 302 may detect voltage levels of the positive electrodes 118 and negative electrodes 120 in the reaction chamber 110, detect a flow rate of the aqueous solution 104 passing through the reaction chamber 110, and detect current applied to the positive electrodes 118 and the negative electrodes 120 in reaction chamber 110. Logic controller 302 may then automatically provide an electrode plate voltage indication alarm indicating an electrode plate degradation when voltage levels across of the positive electrodes 118 and the negative electrodes 120 fall below a predetermined level at a preset current and a preset flow rate, such as the current and flow rate when the positive electrodes 118 and the negative electrodes 120 were initially installed or new.

In block 418, logic controller 302 determines if pH1 and pH2 are within parameters. If pH1 and pH2 are within parameters, logic controller 302 stores the pH control settings in block 420. If the pH1 level is high, logic controller 302 in block 422 sends a signal to cause acid to be injected using citric acid in pH feed 116. If pH1 is determined to be too low in block 424, logic controller 302 causes alkaline blending contact tank blending valve 122 to dissolve an alkaline agent into the fluid stream and then execute block 420 in which the logic controller 302 stores pH control settings.

In block 426, logic controller 302 determines if the power supply 304 is on. If the power supply 304 is on, logic controller 302 reads 320 in block 428 and determines if the TC is normal and if TAN is present, or if the FC is too high. If the TC is normal in block 430, the power settings are stored. If TAN is present, then power, current and/or electrode voltage provided to reaction chamber 110 using the positive electrodes 118 and negative electrodes 120 is increased in block 432, before executing block 430. If FC is high in block 434, the power and/or electrode voltage provided to the positive electrodes 118 and negative electrodes 120 in reaction chamber 110 is decreased, and the power and/or electrode voltage settings are stored in block 430.

If, in block 426, the logic controller 302 determines power supply 304 is off, in block 436, logic controller 302 reads 320. In block 438, logic controller 302 issues a “start power” command based on an estimate of TAN, Nitrogen, pH, and ORP before executing block 430.

In block 440, logic controller 302 determines whether the contact tank blending valve 122 is activated. If the contact tank blending valve 122 is not activated, in block 442, logic controller 302 issues a “start Valve” command, i.e., a disinfection setting.

If the contact tank blending valve 122 is activated, in block 434, a determination is made in block 438 regarding a disinfection setting. In one implementation the disinfection setting is determined by the quantity of bacteria present in the tank 106 from the sensor readings, using the method previously referenced. In another implementation, the disinfection setting can be set by the user (or automatically with logic controller 302) of the system 102, based on levels of bacteria present in the tank 106. Logic controller 302 may automatically change a flow of aqueous solution 104 being fed to the contact tank 112 by opening or closing the contact tank blending valve 122 (as described in block 444, block 446 and block 448) to adjust the presence of nitrites in the aqueous solution 104. If the disinfection setting is off, logic controller 302 stores the open position setting of contact tank blending valve 122 in block 444. If the disinfection setting is low, in block 446, logic controller 302 sets the contact blending valve opening to 50%. If the disinfection setting is high, logic controller 302 sets the blending valve opening to 100% in block 448 and then executes block 444.

After executing block 444, logic controller 302 executes block 450 by storing all values and by restarting the loop. The logic controller 302 restarts the loop by re-executing block 404 to determine whether pump 108 is still running.

While the above description identifies, describes, and details several novel features of the invention, as applied to a preferred embodiment, it should be understood that various omissions, substitutions, and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A method for removing specific contaminants from an aqueous solution by disinfecting and removing organic compounds, ammonia, and ammonium ions that exist in equilibrium in the aqueous solution, the method comprising:
pumping, with a pump having a pump speed, the aqueous solution from a holding vessel, in either a recirculation loop or a linear path, into a reaction chamber that includes positive electrodes and negative electrodes;
supplying electrode voltage with an electric current to the positive electrodes and the negative electrodes to generate a chlorine from chloride ions infused within the aqueous solution in the reaction chamber to kill bacteria and react with the ammonia and the ammonium ions in the aqueous solution;
automatically collecting with sensors measurements from the aqueous solution, the measurements including one or more of Free Chlorine, Total Chlorine, Total Ammonia Nitrogen, pH, the bacteria in the aqueous solution in the holding vessel, and Oxidation Reduction Potential; and
automatically adjusting, in response to the measurements collected from the sensors, one or more of a pump speed, injection of pH precursors prior to the reaction chamber, voltages supplied to the positive electrodes and the negative electrodes in the reaction chamber, the electrical current supplied to the positive electrodes and the negative electrodes in the reaction chamber, a generation rate of the chlorine, and a contact time of the aquious solution in a contact tank coupled with the reaction chamber to kill the bacteria.

2. The method of claim 1 wherein the holding vessel includes a tank, and wherein the electrode voltage with a current is supplied from an electric power source.

3. The method of claim 2 wherein the aqueous solution is fed in response to the pump from the holding vessel to the reaction chamber, the contact tank, a carbon filter, and a remineralization blending system.

4. A computing apparatus comprising:
a processor; and
a memory storing instructions that, when executed by the processor, configure the computing apparatus to:
pump an aqueous solution from a holding vessel through a reaction chamber via a contact tank a carbon filter and a remineralization blending system back to the holding vessel, the reaction chamber containing positive electrodes and negative electrodes to generate chlorine from chloride ions infused within the aqueous solution to react with ammonia and ammonium ions in the aqueous solution;
automatically collect with one or more sensors measurements from the aqueous solution, the measurements including one or more of a Free Chlorine, a Total Chlorine, a Total Ammonia Nitrogen, a pH, a bacteria level, and an Oxidation Reduction Potential; and
automatically adjust, in response to the measurements collected from the sensors, one or more of pump speed, injection of pH precursors, reaction chamber electrode voltage supplied to the positive electrodes and the negative electrodes, a current applied to the positive electrodes and the negative electrodes in reaction chamber, a generation rate of a chlorine from chloride ions infused within the aqueous solution, and a contact time of the aqueous solution in a contact tank coupled with the reaction chamber, to reduce bacteria within the aqueous solution.

5. The computing apparatus of claim 4, wherein the memory storing instructions that, when executed by the processor, configure the computing apparatus:
to detect voltage levels of the positive electrodes and the negative electrodes in the reaction chamber,
to detect a flow rate of the aqueous solution passing through the reaction chamber, and to monitor the current applied to the positive electrodes and the negative electrodes in reaction chamber, and
to automatically provide an electrode plate voltage indication alarm indicating an electrode plate degradation when a voltage level between the positive electrodes and the negative electrodes drop below a predetermined level at a preset current and a preset flow rate.

6. The computing apparatus of claim 4, wherein the memory storing instructions that, when executed by the processor, configure the computing apparatus to detect a presence of nitrites in aqueous solution, and to change a flow of aqueous solution being fed to the contact tank by changing an opening of a contact tank blending valve coupled in parallel with the contact tank to adjust the presence of nitrites in the aqueous solution.

7. The computing apparatus of claim 4 wherein the aqueous solution is pumped either in a recirculation loop or along a linear path.

8. The computing apparatus of claim 4 wherein the holding vessel includes a tank.

9. The computing apparatus of claim 4 wherein the pump of the aqueous solution has a pump speed.

10. An apparatus for removing specific contaminants from an aqueous solution by disinfecting and removing organic compounds, ammonia, and ammonium ions that exist in equilibrium in the aqueous solution comprising:
a pump to move the aqueous solution from a tank or a holding vessel into a pressurized reaction chamber, coupled with a contact tank and a chlorine infuser;
an electrolytic process that converts chloride ions in the aqueous solution such that the aqueous solution in the pressurized reaction chamber reacts with the ammonia and the ammonium ions to generate chloramine;
one or more sensors to automatically collect measurements from the aqueous solution, the measurements including one or more of Free Chlorine, Total Chlorine, Total Ammonia Nitrogen, pH, bacteria in the tank, and Oxidation Reduction Potential; and
logic controller to automatically adjust one or more of a pump speed, an injection of pH precursors, a reaction chamber electrode voltage to control a rate of the electrolytic process, a current to control the rate of the electrolytic process, an infusion rate of a chlorine by the chlorine infuser, and a contact time of the aqueous solution in the contact tank to kill the bacteria.

11. The apparatus of claim 10 wherein the logic controller to automatically adjust one or more of the pump speed, the injection of pH precursors, the reaction chamber electrode voltage to control a rate of the electrolytic process, the current to control the rate of the electrolytic process, the infusion rate of a chlorine by the chlorine infuser, and the contact time of the aqueous solution in the contact tank to kill bacteria includes:
the logic controller to automatically adjust in response to the measurements collected from the one or more sensors one or more of a pump speed, an injection of pH precursors, a reaction chamber electrode voltage to control a rate of the electrolytic process, a current to control a rate of the electrolytic process, an infusion rate of a chlorine by the chlorine infuser, and the contact time of the aqueous solution in the contact tank to kill bacteria.

12. The apparatus of claim 10 wherein the pump moves the aqueous solution from the tank or the holding vessel into the pressurized reaction chamber, either in a recirculation loop or along a linear path.

13. The apparatus of claim 10 wherein the pump moves the aqueous solution along a path from the holding vessel via the reaction chamber via a contact tank, via a carbon filter and vi a a remineralization blending system back to the holding vessel, wherein the aqueous solution remains under pressure along the path.

14. The apparatus of claim 10 wherein the measurements include the Free Chlorine, the Total Chlorine, the Total Ammonia Nitrogen, the pH, and the Oxidation Reduction Potential.

15. The apparatus of claim 10 automatically adjusting, in response to the measurements collected from the sensors, a speed of the pump, the injection of pH precursors, the reaction chamber electrode voltage, current, the infusion rate of the chlorine, and the contact time in the contact tank to kill bacteria.
